(19) United States
(12) Patent Application Publication
(10) Pub. No.: US 2009/0223891 A1
(43) Pub. Date: Sep. 10, 2009

(54) SYSTEM, DEVICE AND METHOD FOR ON-SITE WASTEWATER PROCESSING

(76) Inventor: Ray Gauthier, Duvall, WA (US)

Correspondence Address: BLACK LOWE & GRAHAM, PLLC, 701 FIFTH AVENUE, SUITE 4800, SEATTLE, WA, 98104, US

(21) Appl. No.: 12/043,801

(22) Filed: Mar. 6, 2008

(51) Int. Cl. C02F 3/30

(52) U.S. Cl. 210/605; 210/170.08; 210/532.2; 210/299; 210/631

(57) ABSTRACT

A modular wastewater clarification device that may be positioned external to a septic tank or, alternatively, installed internally within a septic tank chamber to produce sufficiently clean water for lawn and agricultural uses. The modular clarification device includes a filter having a smaller size than the pre-filter bridging between the primary and secondary chambers of a septic tank. In one embodiment, the modular filtration unit resides outside the two-chambered septic tank and receives pre-filtered septic tank effluent fluids stored in the secondary chamber that has accumulated pre-filtered effluent. In another embodiment, the modular wastewater clarification device resides inside the secondary chamber and filters the accumulated pre-filtered effluent. The modular filtration device, having a substantially smaller pore size range than the inter-chamber pre-filter, releases clean water having substantially lowered bacterial and waster related impurities sufficient to meet water release standards suitable for lawn, garden, and agricultural uses.

### FIELD OF THE INVENTION

This invention relates generally to filtration devices and systems for producing clean water from sewage sources, particularly clean water from sewage stored in septic tanks.

### BACKGROUND OF THE INVENTION

Effluents from septic tanks may no longer meet the new water quality emission standards now in force in various municipalities and other governmental jurisdictions. It is advantageous to have an economical solution to bring existing and current septic tank systems in conformity to the new water quality release standards. Alternatively, drainflelds often fail due to overloading. It is advantageous to have an economical solution for the remediation of failed systems.

### SUMMARY OF THE INVENTION

A modular wastewater clarification device that may be positioned external to a septic tank or, alternatively, installed internally within a septic tank chamber to produce sufficiently clean water for lawn and agricultural uses. The modular clarification device includes a filter having a smaller size than the pre-filter bridging between the primary and secondary chambers of a septic tank. In one embodiment, the modular filtration unit resides outside the two-chambered septic tank and receives pre-filtered septic tank effluent fluids stored in the secondary chamber that has accumulated pre-filtered effluent. In another embodiment, the modular wastewater clarification device resides inside the secondary chamber and filters the accumulated pre-filtered effluent. The modular filtration device, having a substantially smaller pore size range than the inter-chamber pre-filter, releases clean water having substantially lowered bacterial and waste related impurities sufficient to meet water release standards suitable for lawn, garden, and agricultural uses.

### BRIEF DESCRIPTION OF THE DRAWINGS

Preferred and alternative examples of the present invention are described in detail below with reference to the following drawings:

FIG. 1 schematically depicts a cross-section of a septic tank effluent wastewater processing system;

FIG. 2 schematically depicts a cross-section of an alternate embodiment of the septic tank effluent wastewater processing system;

FIG. 3 schematically depicts a cross-section of an effluent wastewater clarification device;

FIG. 4 schematically depicts a cross-section of a clarification device chamber;

FIG. 5 schematically depicts a cross-section of a two-chambered septic tank;

FIG. 6 schematically depicts an expansion of the wall region separating the primary and secondary waste chambers;

FIG. 7 schematically depicts a cross-section expansion view of the effluent wastewater pump chamber showing a sewage wastewater effluent pump, control floats and a high water alarm;

FIG. 8 schematically depicts a cross-sectional view of a pump house and clear clean water storage tank with distribution ports to a drain field pipe array;

FIG. 9A schematically depicts side and cross-section views of an alternate embodiment of the effluent wastewater clarification device of FIG. 3 along sectional line A-A;

FIG. 9B schematically depicts side and cross-sectional views of an alternate embodiment with an external gas supply to the diffuser 22 of the clarification filtration device of FIG. 3 along sectional line B-B;

FIG. 9C schematically depicts another side and cross-sectional view of the device depicted in FIG. 3 along sectional lines C-C;

FIG. 9D illustrates an alternate embodiment of the support skirt 14 without a concrete base having fluid ports 15 and supporting the clear water filtration devices depicted in FIGS. 9A-9C;

FIG. 10 schematically depicts an alternate embodiment of the pump house and clean water distribution reservoir depicted in FIG. 2;

FIG. 11 schematically depicts an alternate cross-sectional view of a pump house having a symmetrical array of drainage pipes; and

FIG. 12 schematically depicts other operational parts of the pump house 400 of FIGS. 8 and 11.

### DETAILED DESCRIPTION OF THE PARTICULAR EMBODIMENTS

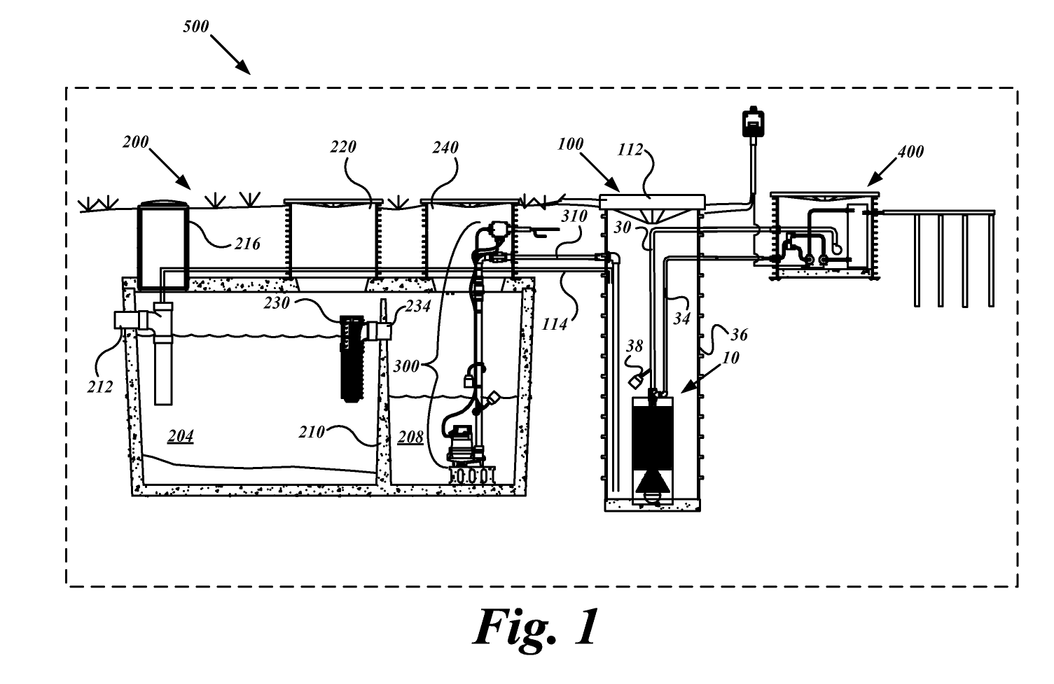

FIGS. 1-12 below illustrate particular embodiments of systems and methods for on-sight wastewater processing and water-remediation. In general, a septic tank pre-filters fluids from primary waste sewage with a filter media having a first porosity. The first porosity may include pore sizes in the approximate range of 1/32 to 1/16 inch to provide a fluid effluent that has gross to medium size particulates removed above this range. The waste fluid effluent is then clarified to clean water status through a filter media having a second porosity. The filtration media within the modular filtration device may be spiral, plate and frame, or other filtration media configurations wherein the second porosity may include a pore size in the range of 0.05 to 0.1 micron diameter. The clean water permeate or filtrate is substantially reduced in bacterial count and any sub-micron indissoluble particulates to render a water quality suitable for lawn and garden, dissemination of clean water to drain fields to foster their improved functioning, and/or to provide clean water for agricultural uses.

FIG. 1 schematically depicts a cross-section of a septic tank effluent wastewater processing system. System 500 includes a modular clarification device 10 housed in a clarification chamber 100 located exterior to a two-chambered septic tank 200. The two-chambered septic tank 200 includes a primary waste chamber 204 and a secondary chamber 208 that receives coarsely pre-filtered waste effluent fluids. A submersible pump assembly 300 resides in the secondary chamber 208 and delivers the pre-filtered accumulated waste effluent fluids to the clarification chamber 100. A pump house 400, having hydraulic and air pumps and related plumbing, controls the hydraulic and operational aspects of the clarification device 10 to deliver clean water to a storage tank located in the pump house 400 and thence to a drainage field or other destination. A recycle pipe 114 is available to route pre-filtered waste effluent fluids back to the primary waste chamber 204 during overflow conditions that may develop within the clarification chamber 100.

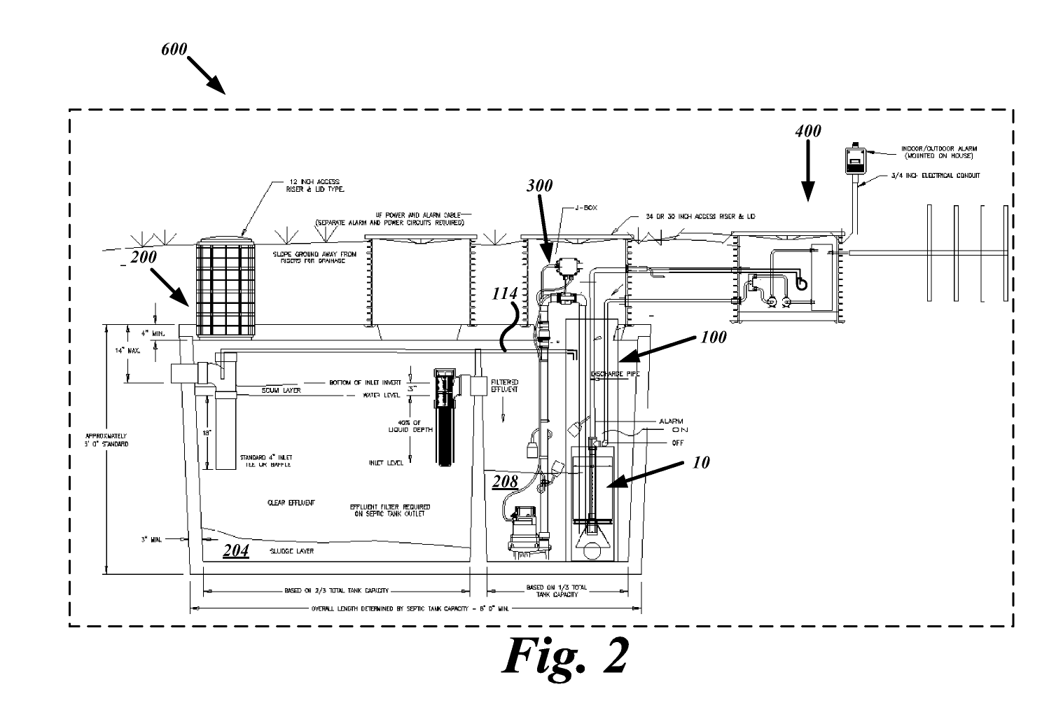

FIG. 2 schematically depicts a cross-section of an alternate embodiment of the septic tank effluent wastewater processing system. Operating in substantially the same way as described above and below, alternate processing system 600 includes the clarification chamber 100, with its clarification device 10, occupying the second chamber 208 adjacent to the submersible pump device 300.

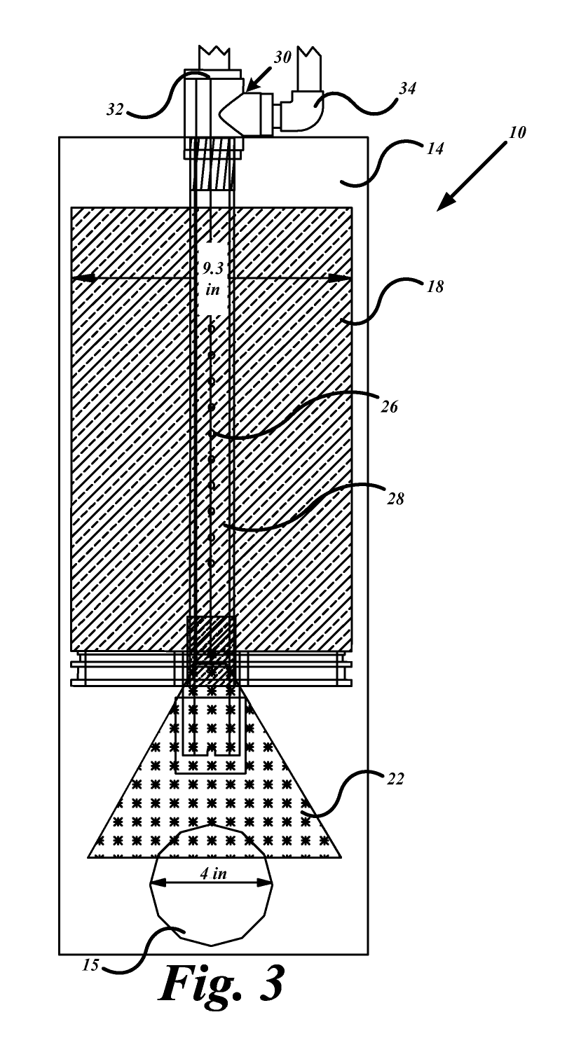

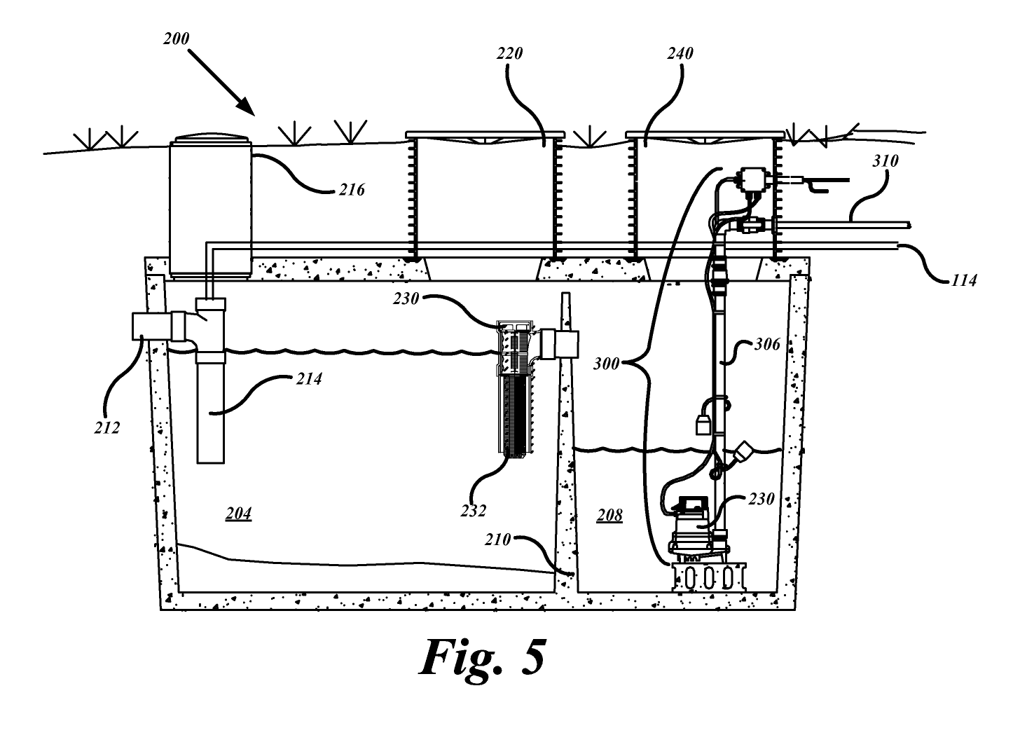

FIG. 3 schematically depicts an effluent wastewater clarification device 10. Clarification device 10 includes a support skirt 14 having at least one waste effluent access port 15 that provides pre-filtered effluent wastewater access to the bottom of the membrane filter 18. Prefilt wastewater is directed and is routed by air bubbles produced by a diffuser 22 into channels of a spiral filter membrane 18. Effluent wastewater is directed from the air diffuser or collection funnel 22 and routed into channels of a spiral filter membrane 18. The spiral filter membrane 18 may include pores sizes approximately one-tenth to one-thousandth the size of the pores of the pre-filter 232 located in the waste chamber 204 as shown in FIGS. 5-7 below. Effluent wastewater is sieved through the spiral filter membrane 18 and is outputted as clarified or clean water in through a series of delivery apertures 26 in a filtrate collection pipe 28. The filtrate collection pipe 28 is then hydraulically coupled to a tee 30 having an air inlet port 32 and a clear water outlet port 34 from the tee 30. A supply of air is routed through the air inlet port 32 to the funnel 22 and thence to the inlet or dirty side of the filter membrane 18. A source of vacuum is delivered to the water outlet port 34 to the outlet side or clean side of the filter membrane 18. As discussed more fully below, vacuum applied to the clean side of the membrane causes the urging or movement of the effluent wastewater from the dirty side of the membrane 18, through it, and onto the clean side of the membrane 18. The delivery of air to the dirty side of the membrane 18 provides a scrubbing or scouring action to dislodge solid material that has taken residence over and within the surface of the membrane in membrane filter 18. Clear water then emerges from the delivery apertures 26 and thence into the collection pipe 28. The width of the membrane 18 may be 9.3 inches and the diameter of the access port 15 may be 4 inches. The effect that these dimensions, while perhaps preferred, are not limiting.

The membrane filter 18 may be cylindrically shaped and include flat sheet filter media having a porosity between approximately 0.05 and 0.1 microns or other size ranges smaller than the pore ranges of the pre-filter 232. Dimensions may vary from forty inches in length and a diameter of up to twenty-four inches. Other dimensions are possible to accommodate smaller or larger capacity and processing rates.

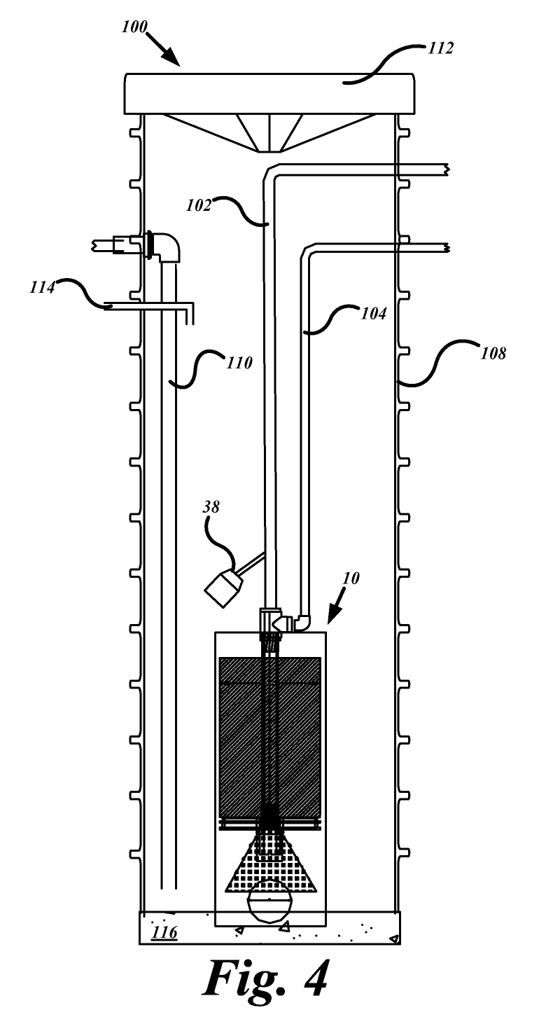

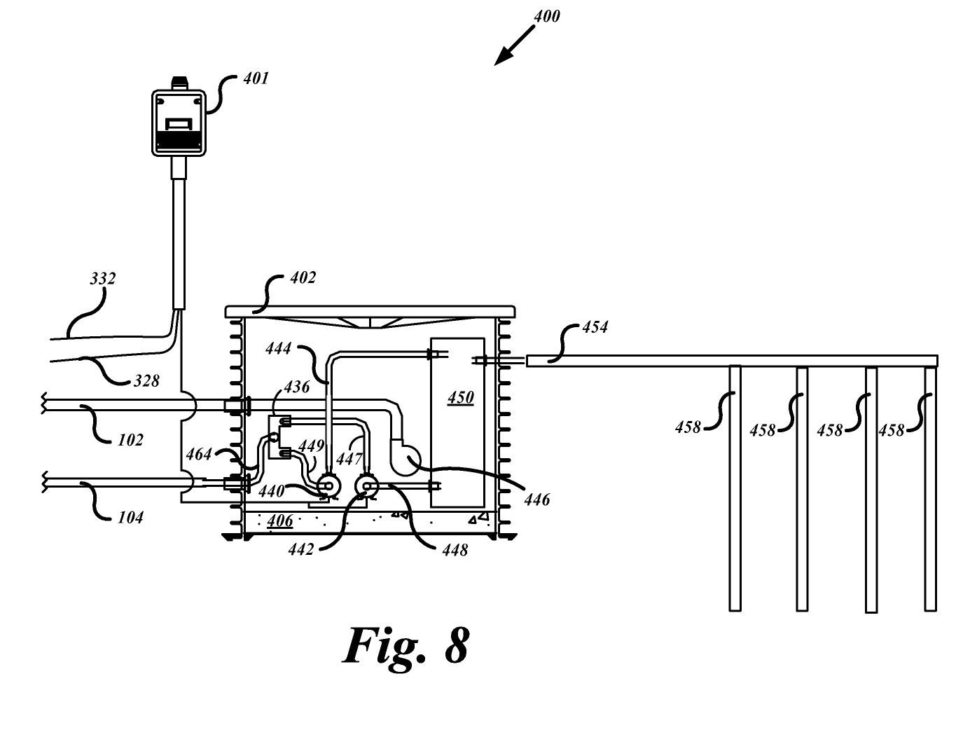

FIG. 4 schematically depicts a cross-sectional view of a clarification device chamber 100 housing the clarification device assembly 10. The clarification device chamber 100 includes housing 108 with an air pipe 102 connected to the inlet port 32 and a clean water permeate pipe 104 connected to the outlet port 34, and is fitted with access port cover 112. Incoming and partially filtered wastewater effluent pumped from the submersible pump 300 assembly depicted in FIGS. 1 above and 5 below is routed near the bottom of the clarification device chamber 100. The incoming wastewater effluent fills the chamber 100 and reaches the activation float 38 located above the clarification device 10. The activation float 38 upon moving engages a switch (not shown) in electrical connection to a vacuum pump 440 and air pump 446 described in FIG. 8 below. The vacuum is then delivered to the clean side of the filter media 18 into the collection pipe 28 and then into the clean water permeate pipe 102, and air is pumped through air pipe 104 for delivery to the dirty side of filter media 18 via the inlet port 32 and then to the funnel diffuser 22. Clean water harvesting and storage is described below. The float level is positioned to maintain fluid levels remain above the clarification device 10 to keep the membrane media 18 sufficiently moist.

FIG. 5 schematically depicts a cross-section of a two-chambered septic tank 200. Septic tank 200 includes a raw-waste reception chamber 204 and an effluent wastewater pump chamber 208. Separating the wastewater reception chamber 204 and effluent wastewater chamber 208 is an inter-chamber wall 206. Wastewater coming from residential or business sources is routed through inlet pipe 212 to a pipe tee baffle 214. The raw solid and liquid waste coming from the residential or businesses accumulate within the raw waste reception chamber 204 to a level that occupies a height in which a partial filtration can begin at the raw waste fluid effluent filter 232. The effluent filter 232 is housed in an effluent filter holder 230 and is in a fluid communication with an outlet pipe 234 that is connected between the inter-chamber wall 206. At the top of the septic tank 200 are three riser ports for access to inspect or maintain various proponents described herein for the septic tank 200. The riser ports include an inlet maintenance riser port 216 that has a view of the pipe tee baffle 214, a filter maintenance riser port 220 to view the effluent filter holder 230 and to service the effluent filter 232. A submersible pump riser port 240 is positioned over the effluent waster water pump chamber 208. Occupying the effluent wastewater 208 is a submersible pump assembly 300. This submersible pump assembly includes a pre-filtered outlet pipe 310.

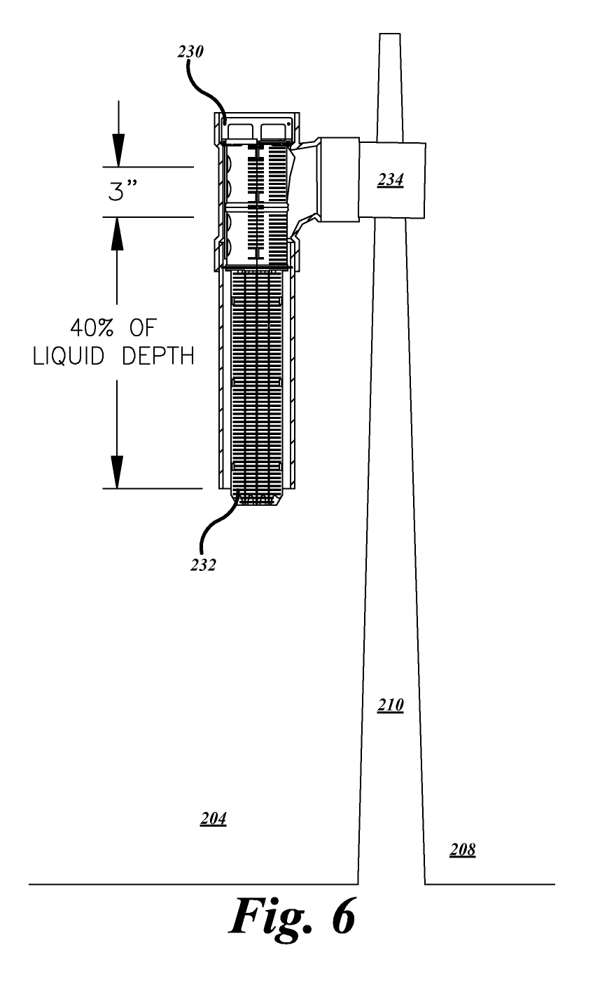

FIG. 6 schematically depicts an expanded cross-sectional view of the inner chamber wall 210 located between the raw waste chamber 204 and effluent water chamber 208. Shown in greater detail are the effluent filter holder 230 and the effluent filter 232. There is a three-inch layer or a three-inch distance that is located near the tee portion of the effluent filter holder 230 and shows the effluent filter 232 that is plungeable up to 40 % of the liquid depth within the raw waste chamber 204. Gravity drives the filtration process to limit particle solid discharge through the submicron to the multi-micron pores of the spiral membrane filter 232, in which the filtrate then is routed through the port 234 into the effluent water chamber 208.

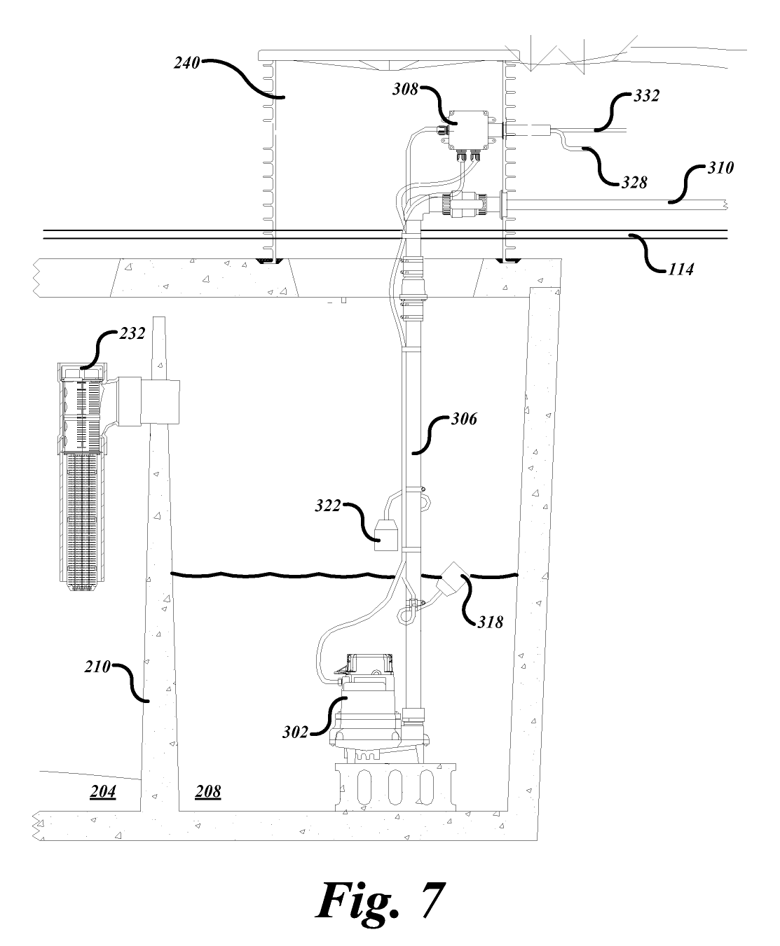

FIG. 7 schematically depicts an expanded cross-sectional view of the wastewater effluent pump assembly 300 and shows a control float 318, an alarm float 322, mounted to a vertically disposed outlet pipe 306. The effluent pump assembly 300 includes the submersible pump 302 in hydraulic communication with the outlet pipe 306 and shows insulated wire connectivity with the control and alarm floats 318 and 322. The effluent pipe 306 extends up into the internal space of the riser 240 and includes a junction box 308 to convey electrical wires to the submersible pump 302 and control and high water floats 318 and 322. Electrical wires 332 and 328 connect to the electrical junction box 308. The outlet pipe 306 is shown in hydraulic communication with wastewater outlet pipe 3 10.

FIG. 8 schematically depicts a cross-sectional view of a pump house 400 connected with a water level alarm 401. High fluid levels in the second chamber 208 arising from movement of the alarm float 322 indicates a failure to process water and is so announced by alarm 401. The pump house 400 may sit upon a base 406.

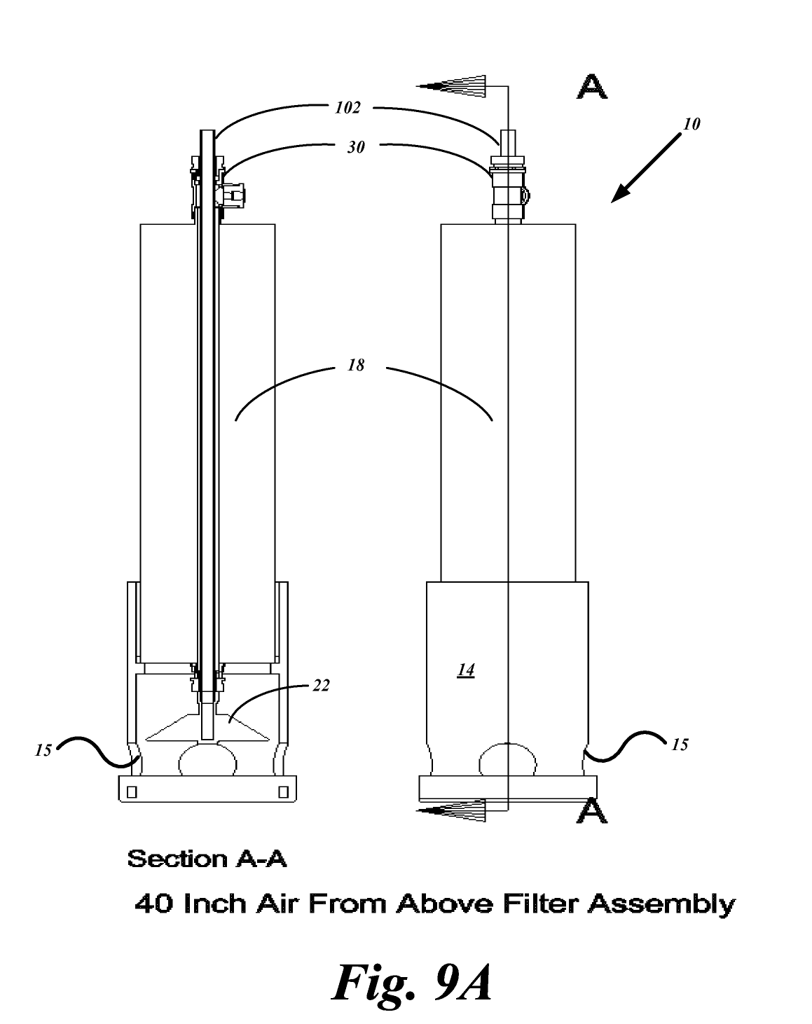

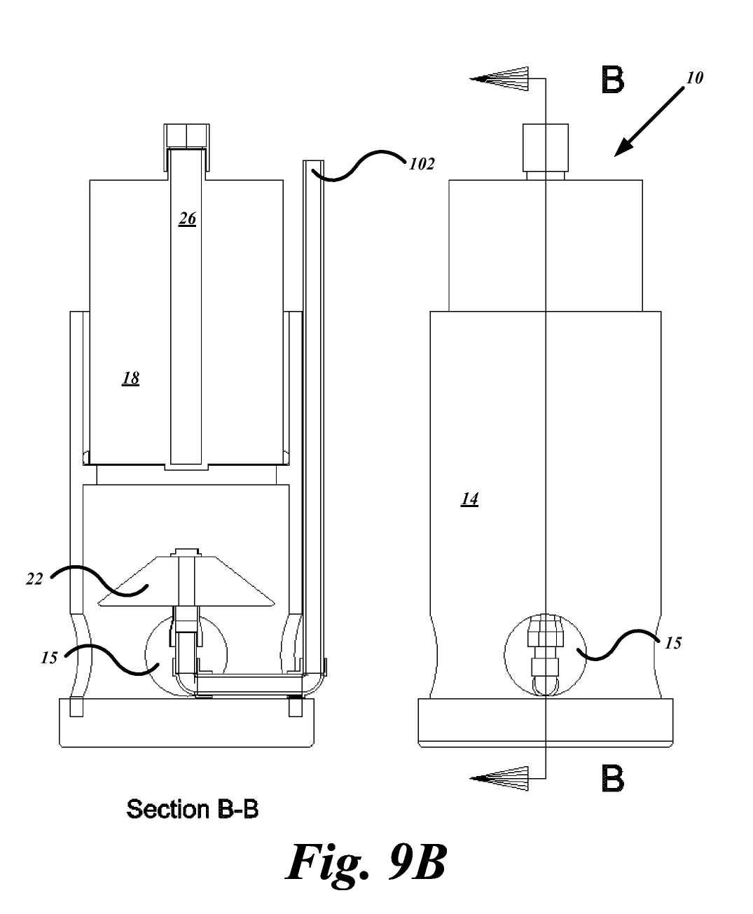

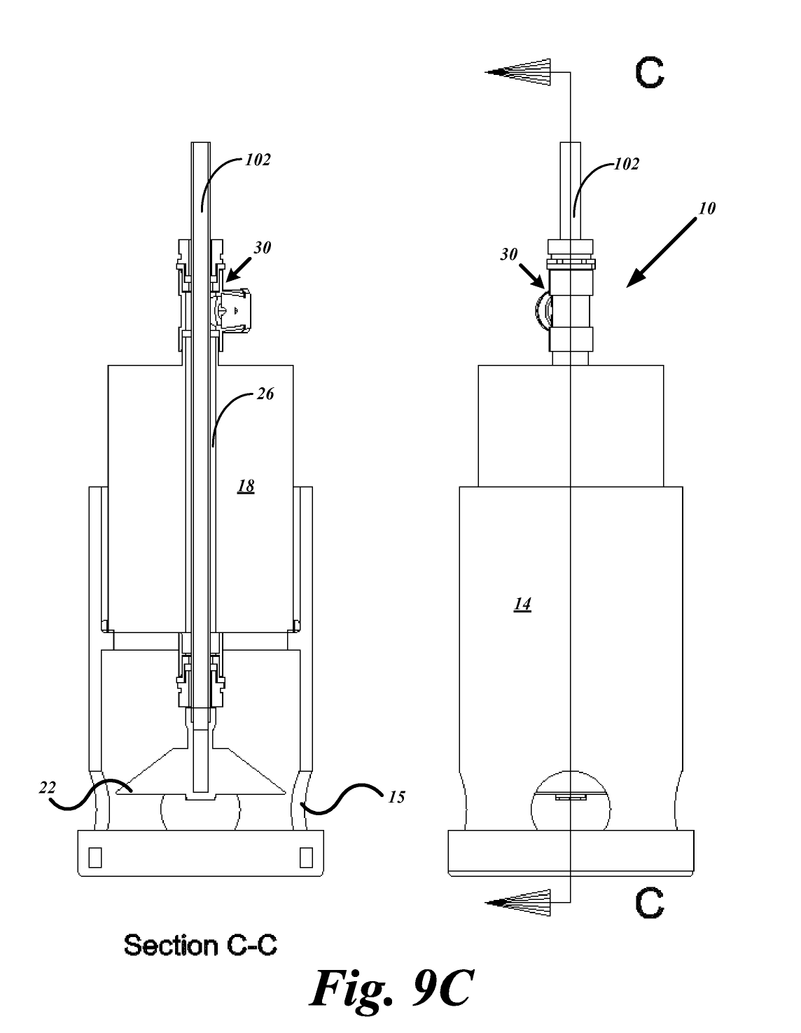

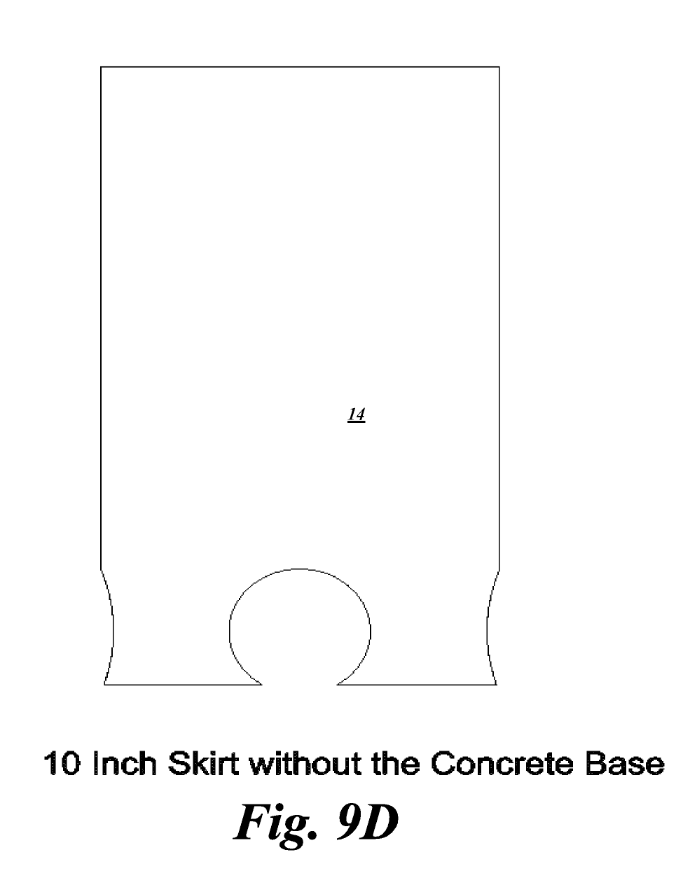

FIG. 9A schematically depicts side and cross-section views of an alternate embodiment of the effluent wastewater clarification device of FIG. 3 along sectional line A-A. Spatial arrangement of the support skirt 14 and its access port 15, the membrane 18, the Tee connector 30, the air diffuser or funnel 22, and the air inlet pipe 102 is shown.

FIG. 9B schematically depicts an alternative configuration of the air supply to diffuser 22, a side and cross-sectional view of the clarification filtration device of FIG. 3 along sectional line B-B.

FIG. 9C schematically depicts another side and cross-sectional view of the device depicted in FIG. 3 along sectional lines C-C.

FIG. 9D illustrates the plastic base skirt without concrete base having fluid ports and supporting the clear water filtration device depicted in FIGS. 9A-9C.

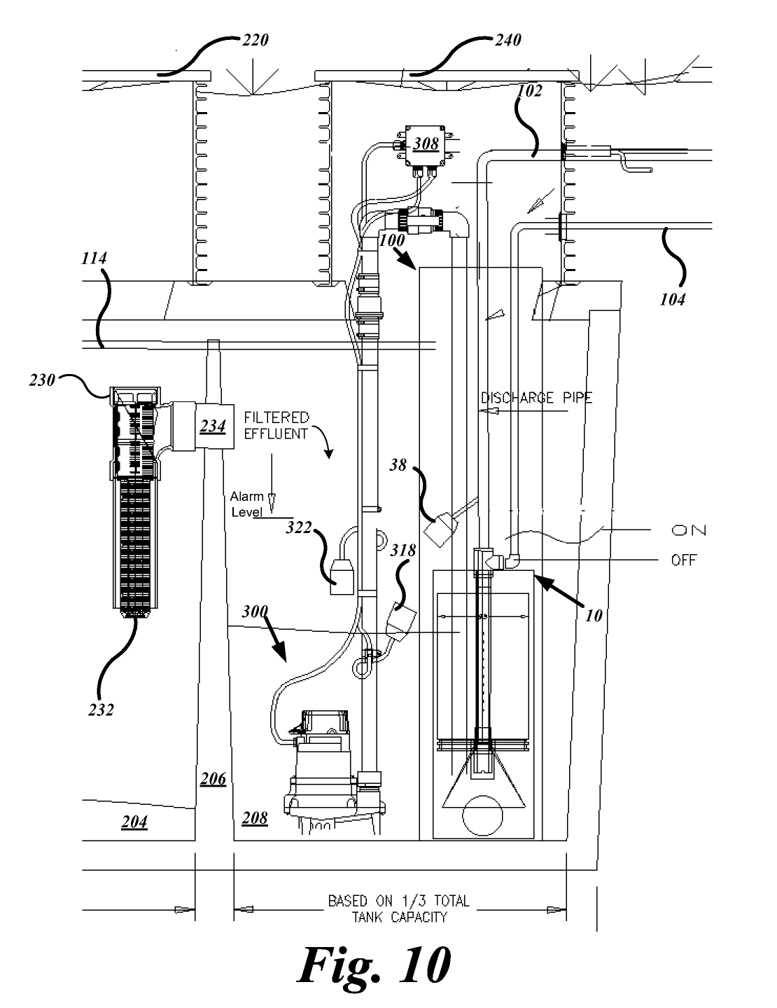

FIG. 10 schematically depicts an alternate embodiment of wastewater processing system having the effluent chamber 208 occupied by the submersible pump assembly 300 and the clarification device chamber 100. In this alternate embodiment, the clarification chamber 100 is shown housed in the effluent wastewater pump chamber 208 adjacent the effluent pump assembly 300. In this embodiment, a more efficient use of space can be achieved by bundling the submersible pump assembly 300 next to the clarification chamber 108.

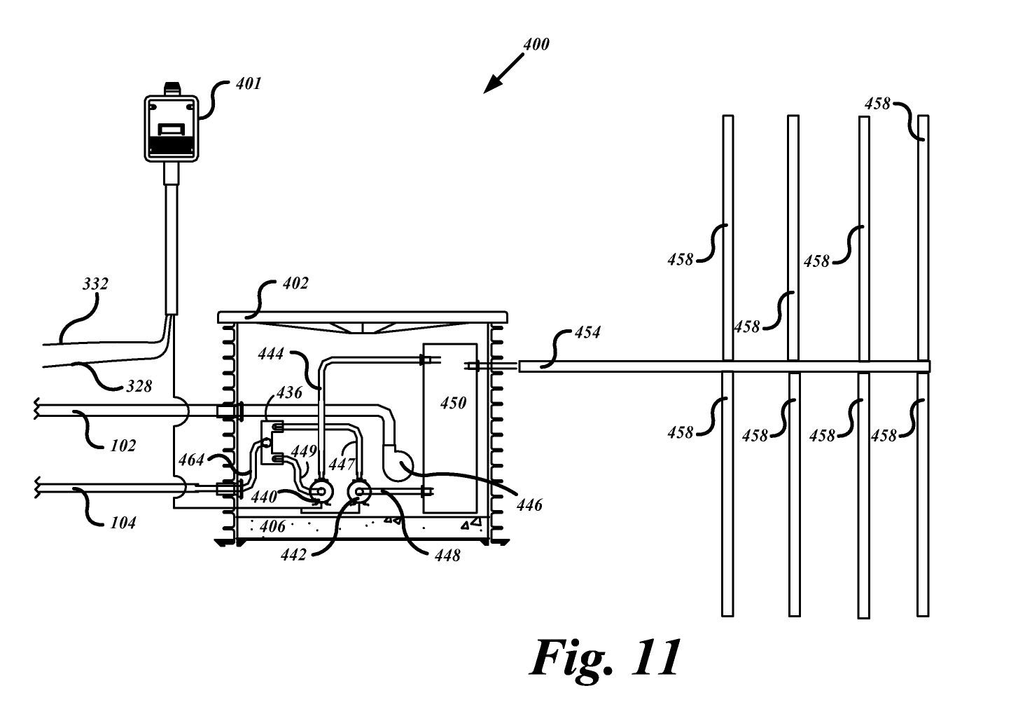

FIG. 11 schematically depicts an alternate cross-sectional view of a pump house having a symmetrical array of drainage pipes 458

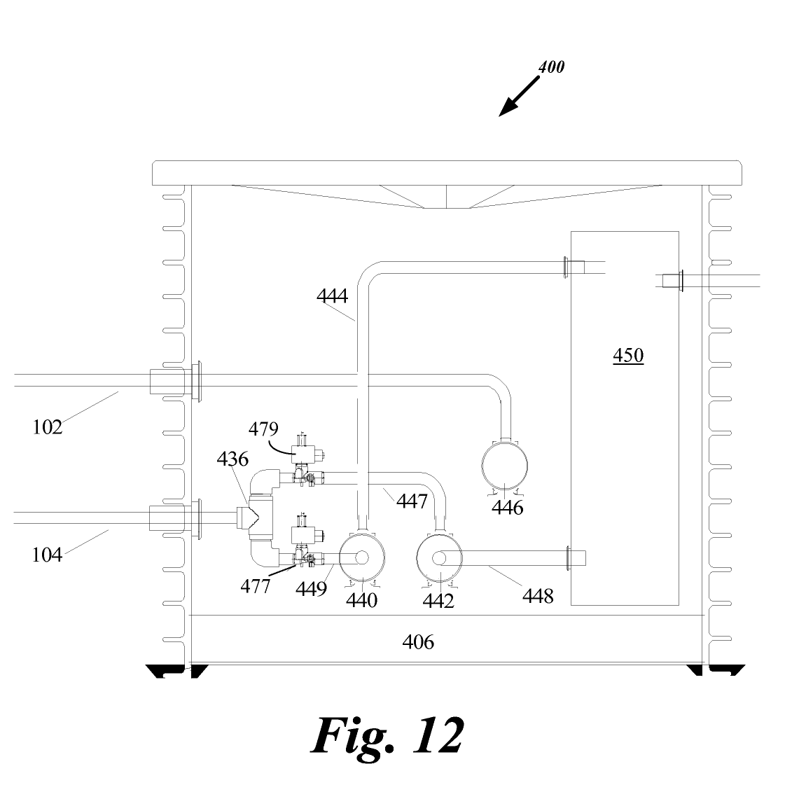

FIG. 12 schematically depicts other operational parts of the pump house 400 of FIGS. 8 and 11. The pump house 400 further includes a three-way tee manifold 436 that is connected with a clean water pump 440 that in turn is connected to a first port of tee manifold 436. A back flush pump 442 is connected with a second port of tee manifold 436 via pipe 447, and an air pump 446 is connected with the air pipe 102. A clean water tank 450 is connected with the downstream or effluent side of the vacuum pump 440 and on the inlet side of the back flush pump 442 via pipes 444 and 448. Clarified water is delivered to the upper portion of tank 450 via delivery pipe 444 and clean water used to back flush the membrane 18 is withdrawn from the bottom side of tank 450 via delivery pipe 448 connected to the inlet side of back flush pump 442. A solenoid switch 477 is installed between tee manifold 436 and effluent pump 440. Another solenoid switch 479 is installed between tee manifold 436 and back flush pump 442. The solenoid switch 477 of tee manifold 436 opens and solenoid switch 479 of tee manifold 436 closes when pump 440 is energized. Alternatively, solenoid switch 477 of tee manifold 436 closes and solenoid switch 479 of tee manifold 436 opens when back flush pump 442 is energized.

When the system is not processing prefilt, it is in the intermittent mode. In the intermittent mode, a timer in the motor control center (not shown) energizes a blower 446 for 5 minutes followed by a fixed pause of time. The blower 446 pushes air via pipe 102 to a diffuser 22. Pipe 102 passes through a compression fitting at port 32 of tee 30 and continues through pipe 28 in membrane filter 18 and passes through another compression fitting at the base of membrane filter 18 before connecting to the top of diffuser 22 as depicted in Figures 9A and 9C. When the diffuser 22 gets air, it produces bubbles, which scour the outside of the membranes in membrane filter 18.

Prefilt enters through inlet pipe 212 to a tee baffle 214 and enters chamber 204 of tank 200. The water level rises until water passes through effluent filter 232 into outlet pipe 234 in inter-chamber wall 210 into chamber 208. The water level rises until activation float switch 318 energizes pump 302. Pump 302 forces prefilt water into pipe 306. Pipe 306 delivers prefilt water via pipes 310 & 110 to clarification tank 108. The water level rises in clarification tank 108 until activation float switch 38 sends a signal to the motor control center (not shown), which energizes a timer that begins the purge cycle. The excess water is returned to chamber 204 through pipe 114. Pipe 114 connects tank 108 with compartment 204 via riser 216 and tee baffle 214.

The purge cycle begins with timer in the motor control center energizing air pump 446 for a short fixed period. After the fixed time period, solenoid switch 477 of tee manifold 436 is closed and solenoid switch 479 is opened. Back flush pump 442 energizes. The outlet of back flush pump 446 connects to solenoid switch 479 via pipe 447. Back flush pump 442 draws water from day tank 450 via pipe 448, which connects the inlet of back flush pump 446 and day tank 450. During the purge cycle, the back flush pump 442 pumps water via pipe 447, pipe 104, port 34 of tee 30 and pipe 28 to the clean side of membrane filter 18. For a period of several minutes clean water moves backwards through the membrane inside membrane filter 18 clearing out the pores of the membrane.

After the purge cycle terminates the run cycle begins. Air pump 446 remains energized throughout the purge and run cycles. The timer ends the purge cycle by de-energizing back flush pump 442, moving the solenoid in the three way tee manifold such that port 477 is open and port 479 is closed and energizing permeate pump 440. The inlet of permeate pump 440 connects to the three way tee manifold 436 via pipe 449. The outlet of permeate pump 440 connects to the top of the day tank 450 via pipe 444. Water is drawn from the clean side of the membranes in membrane filter 18 by effluent pump 440 via pipe 28, port 34 of tee 30, pipe 104, pipe 444, of three way manifold tee 436 and pipe 449. The permeate pump 440 pumps the water to the day tank 450 via pipe 444. Day tank 450 fills until the water level reaches field delivery pipe 454. Field delivery pipe 454 delivers the effluent to the drain field. The timer in the motor control center energizes the effluent pump for 9 minutes on and one minute off or for 8 minutes on and 2 minutes off. A preset purge cycle will initiate during the run cycle as needed. When the prefilt stops entering pipe 212 and tee 214, the water level in chamber 204 drops below the level of filter 230, the water level in chamber 208 falls and lowers the activation float switch 318 which de-energizes pump 302. The water level in tank 108 drops and lowers float switch 38 which no longer sends a signal to the motor control center, blower 446 is de-energized, effluent pump 440 is de-energized and a timer begins the intermittent mode.

Periodically a chemical-based cleaning cycle may be applied, commonly, once or twice a year. Cleaning chemicals to the day tank 450 are introduced and a user manually controls the energizing of the pump motors of pumps 440, 442, and 446 and solenoid switches 477 and 479 in the cleaning cycle. The solenoid switch 477 of tee manifold 436 closes and solenoid switch 479 of tee manifold 436 are opened. Back flush pump 442 is energized for several minutes and draws water and cleaning solution from day tank 450 using pipe 448. The pump 442 pushes the solution into pipe 447, solenoid switch 479, tee manifold 436, pipe 104, tee 30, pipe 28 of membrane filter 18 and through the clean side of the membranes inside membrane filter 18. When pump 442 finishes pumping the system may be set to dormant for a period of 1 to 2 hours. Air pump 446 is de-energized during the chemical cleaning and during the dormant period.

While the preferred embodiment of the invention has been illustrated and described, as noted above, many changes can be made without departing from the spirit and scope of the invention. For example, more than one modular filtration device 10 can be connected in parallel to increase the flow capacity and filtration rates. Other sub-micron filters having ranges larger than or smaller than the approximately 0.05-0.1 micron range may be used in the modular clarification device to tune or adjust to the local water release specification requirements. Another clarification chamber 100 having a sub-micron filter with the same approximate 0.05-0.1 micron filter, or a filter with a range smaller than 0.05-0.1 microns may be installed, thereby establishing a three stage filtration process. For single chamber septic tanks, an external chamber coupling a 1/32- 1/16 inch pre-filter to the fluid out flows from single chamber may be installed, and then connected to a downstream located clarification chamber 100 having a sub-micron filter. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. An onsite wastewater processing system from a septic tank chamber with a pool of pre-filtered wastewater fluid delivered from a first filter having a first porosity, the system comprising:
a submersible pump assembly located in the septic tank chamber; and
a water clarification device having a second filter having a second porosity smaller than the first porosity, the second filter being in fluid communication with the submersible pump assembly, wherein a two-stage filtration process of locally generated wastewater is processed and delivered for clean water purposes from the water clarification device.

2. The system of claim 1, wherein the water clarification device is housed separately from the submersible pump assembly.

3. The system of claim 1, wherein the water clarification device is housed in the chamber.

4. The system of claim 1, wherein the first porosity is approximately 1/32 inch to 1/16 inch.

5. The system of claim 1, wherein the second porosity is approximately 0.05 micron to 0.1 micron.

6. An onsite wastewater processing device in fluid communication with waste effluent fluids having undergone filtration through a media having porosity ranging from approximately 1/32 to 1/16 inch to produce a waste pre-filtrate, the device comprising:
a filter media having a porosity ranging from approximately 0.05 micron to 0.1 micron;
a first hydraulic line in fluid communication with a gas to the inlet side of the filter media; and
a second hydraulic line in fluid communication with a vacuum source to the exit side of the filter media;
wherein gas delivered to the inlet side of the filter media and vacuum delivered to the exit side of the filter media urges the waste pre-filtrate through the filter to produce a clarified filtrate.

7. The device of claim 1, wherein the clarified filtrate includes a water composition having a bacterial content less than the bacterial content of the pre-filtrate.

8. The device of claim 1, wherein the clarified content includes a water composition having a particle count less than the particle count of the pre-filtrate.

9. A method to process wastewater from a septic tank having a pool of pre-filtered wastewater fluid delivered from a first filter having a first porosity, the method comprising:
installing a water clarification device having second filter with a second porosity smaller than the first porosity, the inlet side of the second filter being in fluid communication with the pre-filtered wastewater fluid;
delivering an air supply to the inlet side of the second filter; and
delivering vacuum to the exit side of the second filter
wherein the wastewater fluid traverses across the inlet side and emerges as clean water emerges from exit side of the second filter.

10. The method of claim 9, wherein the second porosity includes a range of approximately 0.05 micron to 0.1 micron in diameter.
